(19) United States
(12) Patent Application Publication
(10) Pub. No.: US 2022/0083533 A1
(43) Pub. Date: Mar. 17, 2022

(54) Performing Operations based on Distributedly Stored Data

(71) Applicant: Telefonaktiebolaget LM Ericsson (publ), Stockholm (SE)

(72) Inventors: Harald Gustafsson, Lund (SE); Fredrik Svensson, Löberöd (SE); Per Persson, Södra Sandby (SE)

(21) Appl. No.: 17/416,556

(22) PCT Filed: Dec. 21, 2018
(86) PCT No.: PCT/EP2018/086749

§ 371 Date: Jun. 21, 2021

(51) Int. Cl. G06F 16/23; G06F 16/27

(52) U.S. Cl. CPC G06F 16/2365; G06F 16/2358; G06F 16/27

(57) ABSTRACT

A method of a controller is disclosed. The method is for management of performing a set of operations based on data, wherein a plurality of representations of the data are kept in respective ones of a plurality of storage entities. The method comprises (for each of two or more storage entities of the plurality of storage entities) sending to the storage entity a respective query relating to the data, and receiving—from the storage entity—a response comprising the representation of the data kept in the storage entity. The method also comprises (for each of at least two of the two or more storage entities) initiating an activity of performing the set of operations based on the representation of the data comprised in the response. Furthermore, the method comprises determining—based on the representations of the data comprised in the responses—one of the initiated activities (a conclusive activity) as being based on a conclusive representation of the data, and causing provision of a result of the conclusive activity as result for performing the set of operations based on the data. Corresponding apparatus, client node and computer program product are also disclosed.

### TECHNICAL FIELD

The present disclosure relates generally to the field of data storage and performing operations based on stored data. More particularly, it relates to performing of operations based on data, wherein a plurality of representations of the data are kept in respective ones of a plurality of storage entities.

### BACKGROUND

In data storage, data is often replicated to several nodes, e.g., to obtain swift data availability and/or prevent data corruption/loss. Thus, several representations of the same data may be kept in different storage entities. For example, in cloud-based systems and in edge compute systems, storage is often distributed over several nodes (e.g., computers, servers, storage units, etc.) and over several tiers of performance (e.g., cache, dynamic random-access memory—DRAM, flash disk, spinning disk, etc.).

Performing a set of operations based on data stored as several representations kept in different storage entities may be time consuming, and the latency until a result of performing the operations is provided may be unacceptably high in some situations.

Therefore, there is a need for alternative approaches for performing a set of operations based on data, wherein a plurality of representations of the data are kept in respective ones of a plurality of storage entities. Preferably, such approaches provide a reduction of the latency from sending of a data query until a result of performing the set of operations is provided.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method of a controller for management of performing a set of operations based on data, wherein a plurality of representations of the data are kept in respective ones of a plurality of storage entities.

The method comprises (for each of two or more storage entities of the plurality of storage entities) sending—to the storage entity—a respective query relating to the data, and receiving—from the storage entity—a response comprising the representation of the data kept in the storage entity.

The method also comprises (for each of at least two of the two or more storage entities) initiating an activity of performing the set of operations based on the representation of the data comprised in the response.

Furthermore, the method comprises determining (based on the representations of the data comprised in the responses) one of the initiated activities—a conclusive activity—as being based on a conclusive representation of the data, and causing provision of a result of the conclusive activity as result for performing the set of operations based on the data.

In some embodiments, activities of performing the set of operations are initiated only for storage entities for which the representation of the data comprised in the response differs from representations of the data comprised in previously received responses.

In some embodiments, the method further comprises determining the conclusive representation of the data by taking a majority, or weighted majority, decision among the representations of the data comprised in the responses.

In some embodiments, the determination of the conclusive activity is performed before all initiated activities are completed.

In some embodiments, the activities are initiated before the determination of the conclusive activity.

In some embodiments, the conclusive representation coincides with the representation of the data kept in the storage entity for at least one of the two or more storage entities.

In some embodiments, the method further comprises, in response to determining the conclusive activity, canceling initiated activities that are not based on the conclusive representation.

In some embodiments, the method further comprises, in response to determining the conclusive activity, canceling all initiated activities, except for one that is based on the conclusive representation.

In some embodiments, the method further comprises, before determining the conclusive activity, canceling or pausing initiated activities for which a probability of being based on the conclusive representation of the data falls below a probability threshold value.

In some embodiments, at least two of the two or more storage entities have differing signaling delay between the controller and the storage entity.

Having differing signaling delay may be interpreted as having different signaling delay according to some embodiments.

In some embodiments, a storage client comprises the controller and one of the two or more storage entities, and the one storage entity keeps a representation of the data which is a default representation or a last known representation.

A second aspect is a method of a controller for management of performing a set of operations based on data, wherein a plurality of representations of the data are kept in respective ones of a plurality of storage entities.

The method comprises (for each of two or more storage entities of the plurality of storage entities) sending—to the storage entity—a respective query relating to the data, thereby causing initiation of an activity of performing the set of operations based on the representation of the data kept in the storage entity, and receiving—from the storage entity—a response comprising an indicator of the representation of the data kept in the storage entity.

The method also comprises determining (based on the indicators comprised in the responses) one of the initiated activities—a conclusive activity—as being based on representation of the data corresponding to a conclusive indicator, and causing provision of a result of the conclusive activity as result for performing the set of operations based on the data.

In some embodiments, the method further comprises determining the conclusive indicator by taking a majority, or weighted majority, decision among the indicators comprised in the responses.

In some embodiments, the determination of the conclusive activity is performed before all initiated activities are completed.

In some embodiments, the activities are initiated before the determination of the conclusive activity.

In some embodiments, the representation of the data corresponding to the conclusive indicator coincides with the representation of the data kept in the storage entity for at least one of the two or more storage entities.

In some embodiments, the method further comprises, in response to determining the conclusive activity, canceling initiated activities that are not based on the representation of the data corresponding to the conclusive indicator.

In some embodiments, the method further comprises, in response to determining the conclusive activity, canceling all initiated activities, except for one that is based on the representation of the data corresponding to the conclusive indicator.

In some embodiments, the method further comprises, before determining the conclusive activity, canceling or pausing initiated activities for which a probability of being based on representation of the data corresponding to the conclusive indicator falls below a probability threshold value.

In some embodiments, at least two of the two or more storage entities have differing signaling delay between the controller and the storage entity.

Having differing signaling delay may be interpreted as having different signaling delay according to some embodiments.

In some embodiments, a storage client comprises the controller and one of the two or more storage entities, and wherein the one storage entity keeps a representation of the data which is a default representation or a last known representation.

The first and second aspects may be described as a method of a controller for management of performing a set of operations based on data, wherein a plurality of representations of the data are kept in respective ones of a plurality of storage entities.

The method comprises (for each of two or more storage entities of the plurality of storage entities) sending—to the storage entity—a respective query relating to the data, and receiving—from the storage entity—a response comprising information relating to the representation of the data kept in the storage entity (the information comprising, e.g., the representation, or an indicator of the representation).

The method also comprises (for each of at least two of the two or more storage entities) causing initiation of an activity of performing the set of operations based on the representation of the data (wherein the initiation may be caused, e.g., by sending of the query or by performing the initiation).

Furthermore, the method comprises determining (based on the information relating to the representations of the data comprised in the responses) one of the initiated activities—a conclusive activity—as being based on representation of the data corresponding to conclusive information relating to the representation of the data (wherein the conclusive information may, e.g., be a conclusive representation of the data or a conclusive indicator), and causing provision of a result of the conclusive activity as result for performing the set of operations based on the data.

Generally, the conclusive activity is one of the initiated activities of performing the set of operations. The initiated activities of performing the set of operations are also referred to as speculative activities later herein. Thus, in that terminology the conclusive activity is one of the speculative activities. The conclusive activity is typically chosen among the initiated activities based on a data consistency decision.

The data consistency decision may, for example, determine one of the representations of the data as a conclusive representation and the conclusive activity may be chosen as an activity that was initiated based on the conclusive representation. For example, a majority decision among the representations of the data comprised in the received responses may provide the conclusive representation.

Alternatively or additionally, the data consistency decision may, for example, determine one of the indicators of representations of the data as a conclusive indicator and the conclusive activity may be chosen as an activity that was initiated based on a representation of the data that corresponds to the conclusive indicator. For example, a majority decision among indicators comprised in the received responses may provide the conclusive indicator.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for a controller and for management of performing a set of operations based on data, wherein a plurality of representations of the data are kept in respective ones of a plurality of storage entities.

The apparatus comprises controlling circuitry configured to cause (for each of two or more storage entities of the plurality of storage entities) sending—to the storage entity—of a respective query relating to the data, and reception—from the storage entity—of a response comprising the representation of the data kept in the storage entity.

The controlling circuitry is also configured to cause (for each of at least two of the two or more storage entities) initiation of an activity of performing the set of operations based on the representation of the data comprised in the response.

Furthermore, the controlling circuitry is configured to cause determination (based on the representations of the data comprised in the responses) of one of the initiated activities—a conclusive activity—as being based on a conclusive representation of the data, and provision of a result of the conclusive activity as result for performing the set of operations based on the data.

A fifth aspect is an apparatus for a controller and for management of performing a set of operations based on data, wherein a plurality of representations of the data are kept in respective ones of a plurality of storage entities.

The apparatus comprises controlling circuitry configured to cause (for each of two or more storage entities of the plurality of storage entities) sending—to the storage entity—of a respective query relating to the data, thereby causing initiation of an activity of performing the set of operations based on the representation of the data kept in the storage entity, and reception—from the storage entity—of a response comprising an indicator of the representation of the data kept in the storage entity.

Furthermore, the controlling circuitry is configured to cause determination (based on the indicators comprised in the responses) of one of the initiated activities—a conclusive activity—as being based on representation of the data corresponding to a conclusive indicator, and provision of a result of the conclusive activity as result for performing the set of operations based on the data.

The fourth and fifth aspects may be described as an apparatus for a controller and for management of performing a set of operations based on data, wherein a plurality of representations of the data are kept in respective ones of a plurality of storage entities.

The apparatus comprises controlling circuitry configured to cause the method steps of any of the first and second aspects, or of the method combining the first and second aspects.

A sixth aspect is a storage client comprising the apparatus of any of the fourth and fifth aspects.

A seventh aspect is a client node comprising the apparatus of any of the fourth and fifth aspects and/or the storage client of the sixth aspect.

In some embodiments, any of the above aspects may additionally have features identical with or corresponding to any of the various features as explained above for any of the other aspects.

An advantage of some embodiments is that alternative approaches are provided for performing a set of operations based on data, wherein a plurality of representations of the data are kept in respective ones of a plurality of storage entities.

Another advantage of some embodiments is that a reduction of the latency—from sending of a data query until a result of performing the set of operations is provided—may be achieved.

Yet an advantage of some embodiments is that reduced power consumption and/or reduced utilization of operation-performing resources may be achieved.

Yet a further advantage is that the result of the performing of the set of operations corresponds to the result achieved when data consistency is obtained before any activity of performing the set of operations is initiated.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1A is a flowchart illustrating example method steps according to some embodiments;

FIG. 1B is a flowchart illustrating example method steps according to some embodiments;

FIG. 2 is a combined flowchart and signaling diagram illustrating example method steps and signaling according to some embodiments;

FIG. 3 is a combined flowchart and signaling diagram illustrating example method steps and signaling according to some embodiments;

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, there may be latency issues when a set of operations are to be performed based on data stored in several representations, each kept by a respective storage entity.

When a set of operations are to be performed based on data stored in several representations, two or more of the representations are typically obtained and a data consistency decision (e.g., a majority decision) is taken to determine which representation of the data to use when the set of operations is performed. The representation of the data that is used for performing the set of operations may be termed a conclusive representation of the data.

For example, if there are seven representations of the data, wherein four of the representations are identical (coincide), that representation is selected as the conclusive representation if a majority decision is applied. To further illustrate this example, assume that four of the seven representations have a first value “a”, that two of the seven representations have a second value “b” and that one of the seven representations has a third value “c”. Then, the conclusive representation has the first value “a” if a majority decision is applied since the representations having the first value “a” are in majority among the seven representations.

There is typically a delay, after sending a data query, before the representations of the data can be obtained. The delay may be more prominent in some cases, e.g., when there is a relatively large geographical distance between the device sending the query and the storage entity keeping the representation of the data, and/or when the storage entity keeping the representation of the data is a slow-access storage entity. Furthermore, the delay may be different for different storage entities.

For example, the first response (comprising a representation of the data) may arrive relatively fast after the query has been sent; for example, if that representation of the data is kept locally and maybe even in a memory/cache comprised in the same apparatus as the querying party. Other responses (comprising a representation of the data) that are needed to obtain data consistency may arrive several orders of magnitude later; e.g., approximately 100 milliseconds or more after the query has been sent for geo-distributed systems.

Thus, the representations of the data may arrive with different delay; at different points in time. These delay issues postpone the majority decision (and thereby the performing of the operations based on the conclusive representation of the data and the provision of a result thereof) until all representations have been obtained.

In the following, embodiments will be described for management of performing a set of operations based on data, wherein a plurality of representations of the data are kept in respective ones of a plurality of storage entities.

A controller (e.g., controlling circuitry or a control entity/module) may be managing the performing of the set of operations. The controller may, for example, be comprised in a storage client.

The plurality of representations of the data provide several sources of truth for the data. The plurality of representations of the data may, for example, be for one or more of: consistency handling, redundancy, reliability, validity, error protection, error detection, error correction, etc.

One or more of the plurality of representations of the data may differ from other representations of the same data. For example, some representations may have undergone an update via a write operation while other representations have not yet undergone the update (e.g., due to signaling delay).

The data can have any suitable form, including (but not limited to) one or more scalar or complex values, one or more vectors, one or more matrices, one or more other data structures, one or more documents, one or more data file, one or more images, one or more videos, one or more audio tracks, etc.

The plurality of storage entities may, for example, comprise storage at different (physical or virtual) nodes and/or storage in different tiers at the same (physical or virtual) node. In some embodiments, different tiers may be comprised in the same storage arrangement (e.g., an arrangement of several computers in a same data center or a same rack of computers).

Generally, different tiers may refer to a lower numbered tier keeping some partial set of data stored in a higher numbered tier, wherein the lower numbered tier has lower latency than the higher numbered tier. For example, tier 0 may be a dynamic random-access memory (DRAM), tier 1 may be a solid-state drive (SSD) disk, and tier 2 may be spinning hard disk.

Furthermore, one or more of the storage entities may apply cloud-based storage. One or more—but not all—of the storage entities may be a local storage entity (e.g., a cache memory or a register) of the controller managing the performing of the set of operations. For example, a storage client may comprise the controller and one storage entity that keeps a representation of the data which is a default representation or a last known representation.

Thus, the storing of the plurality of representations of the data is distributed (e.g., over one or more of: different tiers, different nodes, different geographical locations, etc.)

According to some embodiments, activities of performing the set of operations is initiated before the data consistency decision has been made. Typically, this means that performing of the set of operations is initiated in several instances; each of which may be seen as a speculative activity of performing the set of operations. For example, a speculative activity of performing the set of operations may be initiated based on each of a number of representations of the data (e.g., a number of unique representations of the data).

When used herein, the term “activity of performing the set of operations” may, for example, refer to an activity comprising (or consisting of) performing of the set of operations.

A speculative activity of performing the set of operations may be defined as performing (at least part of) the set of operations before the data consistency decision has been made. Typically, all initiated speculative activities comprise performing of the same set of operations, while the representation of the data that the set of operations are performed based on may differ between initiated speculative activities of performing the set of operations.

Then, when a data consistency decision has been made, some embodiments comprise cancelling speculative activities of performing the set of operations that are not based on a representation of the data corresponding to the data consistency decision (and possibly cancelling duplicate speculative activities of performing the set of operations that are based on a representation of the data corresponding to the data consistency decision). Some embodiments may comprise letting one or more of the speculative activities continue after the data consistency decision has been made, even if they are duplicates and/or are not based on a representation of the data corresponding to the data consistency decision.

Generally, cancelling activities of performing the set of operations may be seen as aborting, stopping, or prematurely ending the activities of performing the set of operations.

In any case, when the data consistency decision has been made, a result of a speculative activity of performing the set of operations that is based on a representation of the data corresponding to the data consistency decision may be provided as result for performing the set of operations based on the data.

The data consistency decision will be referred to herein as providing a conclusive (consistent) representation of the data and/or a conclusive (consistent) indicator of the representation of the data. The conclusive representation of the data may, for example, correspond to one of the representations of the data. The data consistency decision may be a consensus-based decision; e.g., a majority, or weighted majority, decision among, e.g., obtained representations of the data or obtained indicators of the representation of the data.

Performing a set of operations in a speculative activity may, for example, comprise executing a software code portion. The set of operations may comprise an executable, or a software artefact. Alternatively or additionally, the set of operations may comprise execution in hardware. Examples of an executable, or a software artefact, include a software function, a method, a script, a binary executable module, an executable context, a software code portion, etc. Any of these, and/or other, examples of sets of operations may be performed in a speculative activity. A speculative activity of performing the set of operations may, in some scenarios, be termed a speculative execution.

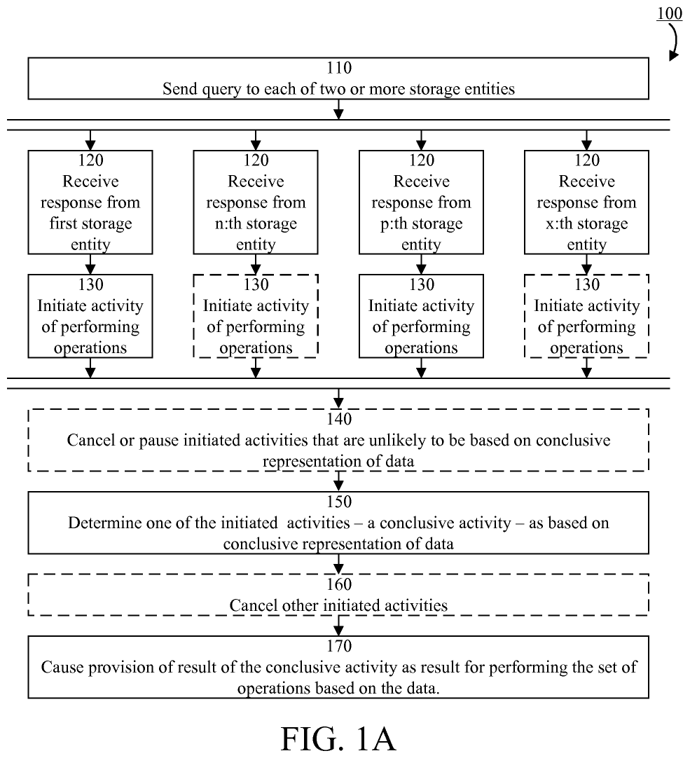

FIG. 1A illustrates an example method 100 according to some embodiments. The method is for a controller, and for management of performing a set of operations based on data, wherein a plurality of representations of the data are kept in respective ones of a plurality of storage entities.

In step 110, a respective query is sent to each storage entity of a collection of storage entities of the plurality of storage entities. How the collection of storage entities are selected from the plurality of storage entities may be in accordance with any suitable approach. Numerous such suitable approaches are known in the art.

The query is related to the data. For example, the query may comprise a request or prompt for the data (the representation of the data kept in the storage entity).

In steps 120, a response (e.g., a query response) is received from two or more storage entities of the collection of entities. The response comprises the representation of the data kept in the storage entity from which the response is received. Typically, the responses are received at different points in time due to different delays, for the different storage entities, between storage entity and the controller. As mentioned before, the different delays may, for example, be due to different signaling delays (e.g., due to different geographical distances) and/or different storage access times.

In FIG. 1A, the two or more storage entities are represented by four storage entities denoted as a first storage entity, an n:th storage entity, a p:th storage entity, and an x:th storage entity.

In some embodiments, a response is received from all storage entities in the collection of storage entities (i.e., the collection of storage entities consists of the two or more entities). In some embodiments, a response is received from less than all storage entities in the collection of storage entities (i.e., the collection of storage entities consists of the two or more entities and one or more other storage entities). In any case, the collection of storage entities comprises the two or more entities. Thus, sending a respective query to each storage entity of the collection of storage entities comprises sending a respective query to each of the two or more storage entities.

For example, a response may be received from seven storage entities; thus providing seven representations of the data wherein, for example, four of the representations have a value “a”, two of the representations have a value “b” and one of the representations has a value “c”.

Activities of performing the set of operations is then initiated for at least two of the two or more storage entities as illustrated by steps 130. Typically, each initiation is performed directly responsive to the reception of the corresponding response. Then, if the responses are received at different points in time, the initiations will be performed at different point in time.

The set of operations may be performed in the controller itself or in an apparatus connected to, or otherwise associated with, the controller. For example, the set of operations may be performed in the storage client, or may be distributedly performed (e.g., cloud-based execution).

The initiated activity is based on the representation of the data comprised in the response.

Typically, activities of performing the set of operations are initiated only for storage entities for which the representation of the data comprised in the response differs from representations of the data comprised in previously received responses (related to the same request for performing the set of operations). Thus, activities of performing the set of operations are initiated only for unique representations of the data. This has the advantage of not unnecessarily utilizing resources (processing hardware, power consumption, etc.) for performing of the set of operations.

For example, an activity of performing the set of operations is typically initiated for the first storage entity (illustrated by a solid line for the corresponding step 130). Then, for each new response it is determined whether the representation of the data comprised in the response coincides with the representation of the data comprised in an already received response.

If so, it may be decided to not initiate any activity of performing the set of operations for that storage entity (illustrated for the n:th and x:th storage entities by a dashed line for the corresponding steps 130).

If the representation of the data comprised in the response does not coincide with any of the representations of the data comprised in already received responses (i.e., if the representation of the data comprised in the response is unique), an activity of performing the set of operations is initiated for that storage entity (illustrated for the p:th storage entities by a solid line for the corresponding step 130).

For the example with seven received responses wherein four of the representations have a value “a”, two of the representations have a value “b” and one of the representations has a value “c”, three (speculative) activities of performing the set of operations may be initiated—one based on the value “a”, one based on the value “b” and one based on the value “c”.

In step 150, one of the initiated activities of performing the set of operations is determined as being based on a conclusive representation of the data. This activity is termed the conclusive activity. Thus, the conclusive activity is one of the initiated activities of performing the set of operations. The determination of the conclusive activity is based on the representations of the data comprised in the responses. For example, step 150 may comprise determining the conclusive representation of the data by taking a majority, or weighted majority, decision among the representations of the data comprised in the responses, and selecting the conclusive activity as an initiated activity of performing the set of operations that is based on a representation of the data that corresponds to (e.g., coincides with) the conclusive representation of the data.

Determining the conclusive representation of the data and/or determining the conclusive activity may be seen as comprised in a data consistency decision.

Thus, the conclusive activity is chosen among the initiated activities based on a data consistency decision, wherein the data consistency decision determines one of the representations of the data as a conclusive representation and the conclusive activity is chosen as an activity that was initiated based on the conclusive representation.

Step 150 may be performed when responses have been received from all storage entities of the collection of storage entities. Alternatively, step 150 may be performed before responses have been received from all storage entities of the collection of storage entities, e.g., when a certain number of responses have been received (e.g., the number exceeding a threshold value), or when a certain number of responses comprising the same representation of the data have been received (e.g., the number exceeding a threshold value).

Typically, step 150 is performed before all initiated activities of performing the set of operations are completed.

In response to determining the conclusive activity, initiated activities that are not based on the conclusive representation may be cancelled as illustrated by optional step 160. Alternatively or additionally, all initiated activities, except for one that is based on the conclusive representation, may be cancelled in response to determining the conclusive activity as also illustrated by optional step 160.

This may have the advantage of not unnecessarily utilizing resources (processing hardware, power consumption, etc.) for performing the set of operations.

It should be noted that, in some embodiments, also initiated activities other than the conclusive activity (e.g., all initiated activities) are allowed to be completed even after the conclusive activity is determined. This may be beneficial, for example, if it is computationally and/or signal-wise cheaper to allow continued performance of operations than to cancel performance of operations.

In some embodiments, some initiated activities may be cancelled or paused even before the conclusive activity is determined as illustrated by optional step 140. For example, initiated activities may be cancelled or paused for which a probability of being based on the conclusive representation of the data falls below a probability threshold value.

The threshold value may be equal to zero (cancelling/pausing only for representations that cannot become the conclusive representation), or may be larger than zero but less than one (cancelling/pausing for representations that cannot become the conclusive representation and for representations that are unlikely to become the conclusive representation).

The probability of being based on the conclusive representation may be estimated via intermediate data consistency decisions. For example, if ten responses are needed for determining the conclusive representation and if eight responses have been received which comprises a first representation of the data once, a second representation of the data thrice, and a third representation of the data four times, it is clear that the first representation of the data cannot become the conclusive representation. Then the initiated activity of performing the set of operations based on the first representation of the data may be cancelled.

This may have the advantage of not unnecessarily utilizing resources (processing hardware, power consumption, etc.) for performing the set of operations.

In step 170, a result of the conclusive activity is provided (or is caused to be provided) as result for performing the set of operations based on the data.

Since the conclusive activity is initiated (as one of the speculative activities of performing the set of operations) before the data consistency decision, the overall latency may be decreased compared to when the data consistency decision is taken before performing the set of operations.

Continuing the example with seven received responses wherein four of the representations have a value “a”, two of the representations have a value “b” and one of the representations has a value “c”, the conclusive representation has the value “a” if a majority decision is applied. The two (speculative) activities that were initiated based on the value “b” and based on the value “c” may be cancelled when the conclusive representation is determined, and the result of the (speculative) activity that was initiated based on the value “a” may be provided as result for performing the set of operations based on the data.

FIG. 1B illustrates an example method 105 according to some embodiments. The method is for a controller, and for management of performing a set of operations based on data, wherein a plurality of representations of the data are kept in respective ones of a plurality of storage entities.

For example, seven representations of the data may be kept in different storage entities wherein, for example, four of the representations have a value “a”, two of the representations have a value “b” and one of the representations has a value “c”.

In step 110, a respective query is sent to each storage entity of a collection of storage entities of the plurality of storage entities. How the collection of storage entities are selected from the plurality of storage entities may be in accordance with any suitable approach. Numerous such suitable approaches are known in the art.

The query is related to the data. For example, the query may comprise a request or prompt for the data (the representation of the data kept in the storage entity), or a request for an indicator of the representation of the data. The indicator may be more easily conveyed than the data (e.g., it may be more compact). The indicator may be derived from the (representation of the) data. For example, the indicator may be a compressed version of the data, a hash-function of the data, a checksum of the data, a data fingerprint, a cryptographic hash-function of the data, etc.

Furthermore, the query is configured to cause initiation of an activity of performing the set of operations based on the representation of the data kept in the storage entity as illustrated by sub-steps 135 for four example storage entities denoted as a first storage entity, an n:th storage entity, a p:th storage entity, and an x:th storage entity. This may, for example, be achieved by including an operation request, a software function identifier, an executable, or similar in the query. The initiated activity is based on the representation of the data kept in the storage entity. Typically, each initiation is performed directly responsive to the reception of the query.

The set of operations may be performed at the corresponding storage entity. The set of operations may be performed in the storage entity itself or in an apparatus connected to, or otherwise associated with, the storage entity. For example, the set of operations may be distributedly performed (e.g., cloud-based execution).

For example, an SQL (structured query language) query can cause activities of performing a set of operations to be initiated before returning a response. Examples of such activities includes simple processing (e.g., summing) and advanced processing (e.g., execution of registered software function).

For the example with seven representations of which four representations have a value “a”, two of the representations have a value “b” and one of the representations has a value “c”, seven (speculative) activities of performing the set of operations may be initiated—four based on the value “a”, two based on the value “b” and one based on the value “c”.

In steps 125, a response (e.g., a query response) is received from two or more storage entities of the collection of entities. The response comprises an indicator of the representation of the data kept in the storage entity from which the response is received. Typically, the responses are received at different points in time due to different delays, for the different storage entities, between storage entity and the controller. As mentioned before, the different delays may, for example, be due to different signaling delays (e.g., due to different geographical distances) and/or different storage access times.

In some embodiments, a response is received from all storage entities in the collection of storage entities (i.e., the collection of storage entities consists of the two or more entities). In some embodiments, a response is received from less than all storage entities in the collection of storage entities (i.e., the collection of storage entities consists of the two or more entities and one or more other storage entities). In any case, the collection of storage entities comprises the two or more entities. Thus, sending a respective query to each storage entity of the collection of storage entities comprises sending a respective query to each of the two or more storage entities.

Typically, the responses are received before the initiated activities of performing the set of operations are completed.

In step 150, one of the initiated activities of performing the set of operations is determined as being based on representation of the data corresponding to a conclusive indicator. This activity of performing the set of operations is termed the conclusive activity. Thus, the conclusive activity is one of the initiated activities of performing the set of operations.

The determination of the conclusive activity is based on the indicators of the representations of the data comprised in the responses. For example, step 150 may comprise determining the conclusive indicator by taking a majority, or weighted majority, decision among the indicators comprised in the responses, and selecting the conclusive activity as an initiated activity of performing the set of operations that is based on a representation of the data that corresponds to the conclusive indicator.

Determining the conclusive indicator and/or determining the conclusive activity may be seen as comprised in a data consistency decision.

Thus, the conclusive activity is chosen among the initiated activities based on a data consistency decision, wherein the data consistency decision determines one of the indicators of representations of the data as a conclusive indicator and the conclusive activity is chosen as an activity that was initiated based on a representation of the data that corresponds to the conclusive indicator.

Preferably, the conclusive activity is selected among the initiated activities that are based on representations corresponding to the conclusive indicator, as the initiated activity that is expected to be completed first.

Step 150 may be performed when responses have been received from all storage entities of the collection of storage entities. Alternatively, step 150 may be performed before responses have been received from all storage entities of the collection of storage entities, e.g., when a certain number of responses have been received (e.g., the number exceeding a threshold value), or when a certain number of responses comprising the same indicator have been received (e.g., the number exceeding a threshold value).

Typically, step 150 is performed before all initiated activities of performing the set of operations are completed.

In response to determining the conclusive activity, initiated activities of performing the set of operations that are not based on a representation corresponding to the conclusive indicator may be cancelled as illustrated by optional step 160. Alternatively or additionally, all initiated activities of performing the set of operations, except for one that is based on a representation corresponding to the conclusive indicator, may be cancelled in response to determining the conclusive activity as also illustrated by optional step 160.

This may have the advantage of not unnecessarily utilizing resources (processing hardware, power consumption, etc.) for performing the set of operations.

It should be noted that, in some embodiments, also initiated activities other than the conclusive activity (e.g. all initiated activities) are allowed to be completed even after the conclusive activity is determined. This may be beneficial, for example, if it is computationally and/or signal-wise cheaper to allow continued performance of operations than to cancel performance of operations.

In some embodiments, some initiated activities of performing the set of operations may be cancelled or paused even before the conclusive activity is determined as illustrated by optional step 140. For example, initiated activities may be cancelled or paused for which a probability of being based on the representation corresponding to the conclusive indicator of the data falls below a probability threshold value.

The probability threshold value may be equal to zero (cancelling/pausing only for representations that correspond to an indicator that cannot become the conclusive indicator), or may be larger than zero but less than one (cancelling/pausing representations that correspond to an indicator that cannot become the conclusive indicator and for representations that correspond to an indicator that is unlikely to become the conclusive indicator).

The probability of being based on a representation that corresponds to the conclusive indicator may be estimated via intermediate data consistency decisions as explained above in connection to FIG. 1A.

This may have the advantage of not unnecessarily utilizing resources (processing hardware, power consumption, etc.) for performing the set of operations.

In step 170, a result of the conclusive activity is provided (or is caused to be provided) as result for performing the set of operations based on the data.

Since the conclusive activity is initiated (as one of the speculative activities of performing the set of operations) before the data consistency decision, the overall latency may be decreased compared to when the data consistency decision is taken before performing the set of operations.

Continuing the example with seven representations of which four representations have a value “a”, two of the representations have a value “b” and one of the representations has a value “c”, seven responses may be received wherein four comprise an indicator having the value “a1” (derivable from the representation having value “a”), two comprise an indicator having the value “b1” (derivable from the representation having value “b”) and one comprises an indicator having the value “c1” (derivable from the representation having value “c”). Then, the conclusive indicator has the value “a1” (corresponding to the representation having the value “a”) if a majority decision is applied. The two (speculative) activities that were initiated based on the value “b” and the (speculative) activity that was initiated based on the value “c” may be cancelled when the conclusive representation is determined, as well as three of the four (speculative) activities that were initiated based on the value “a”. The result of the non-cancelled (speculative) activity that was initiated based on the value “a” may be provided as result for performing the set of operations based on the data.

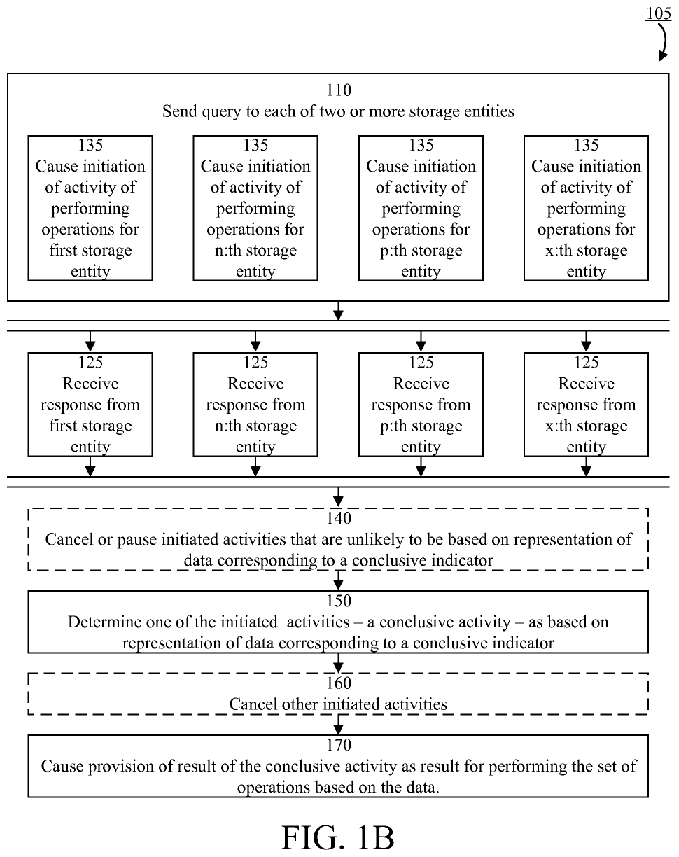

FIG. 2 illustrates method steps and signaling to exemplify some embodiments implementing the method 100 of FIG. 1A.

FIG. 2 schematically shows a client node (CN) 200 comprising an application (APP) 201 and a storage client (SC) 202, which in turn comprises a storage client library (SCL) 203 and a local storage entity (SE) 204. The local storage entity may, for example, be a cache memory. FIG. 2 also schematically shows three storage nodes (SN) 291, 292, 293, wherein storage node 291 comprises a storage entity (SE) 294, storage node 292 comprises two storage entities (SE) 295, 296, and storage node 293 comprises a storage entity (SE) 297. The two storage entities 295, 296 may, for example, be a tier 0 storage entity 295 and a tier 1 storage entity 296.

The storage client and/or the storage client library may be interpreted as comprising the controller configured to perform the method 100 of FIG. 1A, for management of performing a set of operations based on data. A plurality of representations of the data are kept in respective ones of the storage entities 204, 294, 295, 296, 297.

The process of FIG. 2 starts by the application 201 sending a trigger signal 280 to the storage client 202. The trigger signal may typically comprise a query and a software function identifier, for example. The trigger signal 280 is received at the storage client library 203 as illustrated by 205.

In step 210 (compare with step 110 of FIG. 1A), a respective query 281a-e is sent to each of the storage entities. The respective queries may typically be based on the trigger signal 280. For example, a query included in the trigger signal 280 may be used as, or may translate to, the queries 281a-e.

In steps 220a-e (compare with steps 120 of FIG. 1A), a response 282a-e is received from each of the storage entities. The response comprises the representation of the data kept in the storage entity from which the response is received. The responses are received at different points in time due to different delays, for the different storage entities, between storage entity and the storage client library.

First, in step 220a, a response 282a is received from the local storage entity 204. An activity of performing the set of operations—based on the representation of the data kept in the local storage entity 204 and comprised in the response 282a—is initiated responsive to the reception of the response 282a, as illustrated by step 230a (compare with steps 130 of FIG. 1A) and initiation signal 283a. In this example, the set of operations for the local storage entity 204 are performed in the storage client as illustrated by 231a.

Later, in step 220b, a response 282b is received from the storage entity 294. It is checked whether the representation of the data comprised in response 282b differs from the representation of the data comprised in response 282a. If so, an activity of performing the set of operations—based on the representation of the data kept in the storage entity 294 and comprised in the response 282b—is initiated responsive to the reception of the response 282b, as illustrated by step 230b (compare with steps 130 of FIG. 1A) and initiation signal 283b. In this example, the set of operations for the storage entity 294 are also performed in the storage client as illustrated by 231b.

Even later, in steps 220c-e, responses 282c-e are received from the storage entities 295, 296, 297. For each response, it is checked whether the representation of the data comprised in the response differs from the representation of the data comprised in any previously received response. If so, an activity of performing the set of operations—based on the representation of the data kept in the storage entity and comprised in the response—is initiated responsive to the reception of the response (compare with steps 130 of FIG. 1A). If not, no new activity of performing the set of operations is initiated. The latter is the case for the example of FIG. 2 in relation to the responses 282c-e.

For example, the responses 282c and 282e may comprise representations of the data that coincide with the representation of the data comprised in the response 282a, and the response 282d may comprise a representation of the data that coincides with the representation of the data comprised in the response 282b.

In step 250 (compare with step 150 of FIG. 1A), one of the initiated activities 231a, 231b of performing the set of operations is determined as being based on a conclusive representation of the data. The determination of the conclusive activity is based on the representations of the data comprised in the responses. For example, step 250 may comprise determining the conclusive representation of the data by taking a majority decision among the representations of the data comprised in the responses, and selecting the conclusive activity as an initiated activity of performing the set of operations that is based on a representation of the data that coincides with the conclusive representation of the data.

In the example of FIG. 2, the initiated activity 231a is determined as the conclusive activity. This may, for example be due to that it is based on a representation of the data that was comprised in a majority 282a, 282c, 282e of the responses 282a-e.

In response to determining the conclusive activity 231a, the initiated activity 231b is cancelled as illustrated by step 260 (compare with step 160 of FIG. 1A) and cancellation signal 284, because it is not based on the conclusive representation.

When the conclusive activity is completed, the result 285 thereof is provided to the application 201 as result for performing the set of operations based on the data, as illustrated by step 270 (compare with step 170 of FIG. 1A) and result signal 286.

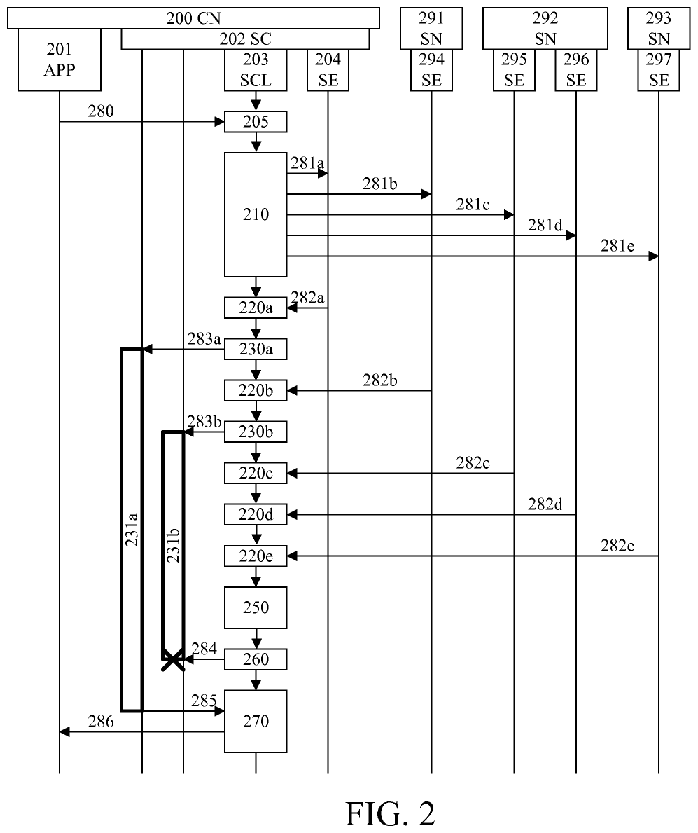

FIG. 3 illustrates method steps and signaling to exemplify some embodiments implementing the method 105 of FIG. 1B.

FIG. 3 schematically shows a client node (CN) 300 comprising an application (APP) 301 and a storage client (SC) 302, which in turn comprises a storage client library (SCL) 303. FIG. 3 also schematically shows three storage nodes (SN) 391, 392, 393, wherein storage node 391 comprises a storage entity (SE) 394, storage node 392 comprises two storage entities (SE) 395, 396, and storage node 393 comprises a storage entity (SE) 397. The two storage entities 395, 396 may, for example, be a tier 0 storage entity 395 and a tier 1 storage entity 396.

The storage client and/or the storage client library may be interpreted as comprising the controller configured to perform the method 105 of FIG. 1B, for management of performing a set of operations based on data. A plurality of representations of the data are kept in respective ones of the storage entities 394, 395, 396, 397.

The process of FIG. 3 starts by the application 301 sending a trigger signal 380 to the storage client 302. The trigger signal may typically comprise a query and a software function identifier, for example. The trigger signal 380 is received at the storage client library 303 as illustrated by 305.

In step 310 (compare with step 110 of FIG. 1B), a respective query 381b-e is sent to each of the storage entities. The respective queries may typically be based on the trigger signal 380. For example, a query included in the trigger signal 380 may be used as, or may translate to, the queries 381b-e.

The queries 381b-e are related to the data. For example, the queries 381b-e may comprise a request for a hash-function of the data. Furthermore, the queries 381b-e are configured to cause initiation (compare with sub-steps 135 of FIG. 1B) of activities of performing the set of operations based on the representation of the data kept in the storage entities, as illustrated by 331b-e.

In steps 320b-e (compare with steps 125 of FIG. 1B), a response 382b-e is received from each of the storage entities. The response comprises an indicator (in this example, a hash-function) of the representation of the data kept in the storage entity from which the response is received. The responses are received at different points in time due to different delays, for the different storage entities, between storage entity and the storage client library.

For example, the responses 382b, 382c and 382e may comprise the same indicator value (hash-value), and the response 382d may comprise another indicator (hash-value).

In step 350 (compare with step 150 of FIG. 1B), one of the initiated activities 331b-e of performing the set of operations is determined as being based on representation of data corresponding to a conclusive indicator. The determination of the conclusive activity is based on the indicators comprised in the responses. For example, step 350 may comprise determining the conclusive indicator by taking a majority decision among the indicators comprised in the responses, and selecting the conclusive activity as an initiated activity of performing the set of operations that is based on a representation of the data that correspond to the conclusive indicator.

In the example of FIG. 3, the initiated activity 331b is determined as the conclusive activity. This may, for example be due to that it is based on a representation of the data that was comprised in a majority 382b, 382c, 382e of the responses 382b-e, and due to that it is expected to be completed before the initiated activities 331c and 331e.

In response to determining the conclusive activity 331b, the initiated activities 331c-e are cancelled as illustrated by step 360 (compare with step 160 of FIG. 1B) and cancellation signals 384c-e, because they are either not based on a representation corresponding to the conclusive indicator, or are presumed duplicates of the conclusive activity.

When the conclusive activity is completed, the result 385 thereof is provided to the application 301 as result for performing the set of operations based on the data, as illustrated by step 370 (compare with step 170 of FIG. 1B) and result signal 386.

Some examples of the triggering (compare with triggering signals 280, 380) of the above-described methods will now be given. Such triggering may, for example, be implemented in an application interface.

Typically, the application sends an instruction to the storage client for triggering speculative performance of a set of operations (e.g., speculative execution). The instruction typically includes an operation request, a software function identifier, an executable, or similar.

An executable could be represented in many different ways, e.g., by reference to a symbol or position in the executable image (of the application), by a copy of an executable blob, by interpretable code or script, by a copy of—or reference to—bytecode, etc.

The instruction may also comprise a scheduling policy for scheduling of the speculative executions. An example scheduling policy might be to schedule initiations of speculative executions on resources with successively lower processing speed (to allow the first-initiated execution(s) to finish as early as possible).

The instruction may also comprise context, e.g., data structures declared before any call to the executable, software functions or libraries declared elsewhere, etc.

The instruction may further comprise the query. The query could be formulated in many ways, e.g., as a key to value lookup, as an SQL query, as a graph query, etc.

An example of a direct application interface may be expressed in pseudo code as:
def myfunc(value):
   return heavyprocessing.do(value)
mykey=“something”
response=storageclient.getkey(myfunc, mykey)

An example of a more evolved application interface may be expressed in pseudo code as:
mykey=“something”
with StorageClient(key=mykey) as client:
   response=spawn heavyprocessing.do(client.value)

Here myfunc denotes an executable, value denotes representation of data, and mykey denotes a query. In the more evolved application interface, the executable is the expression after the spawn keyword.

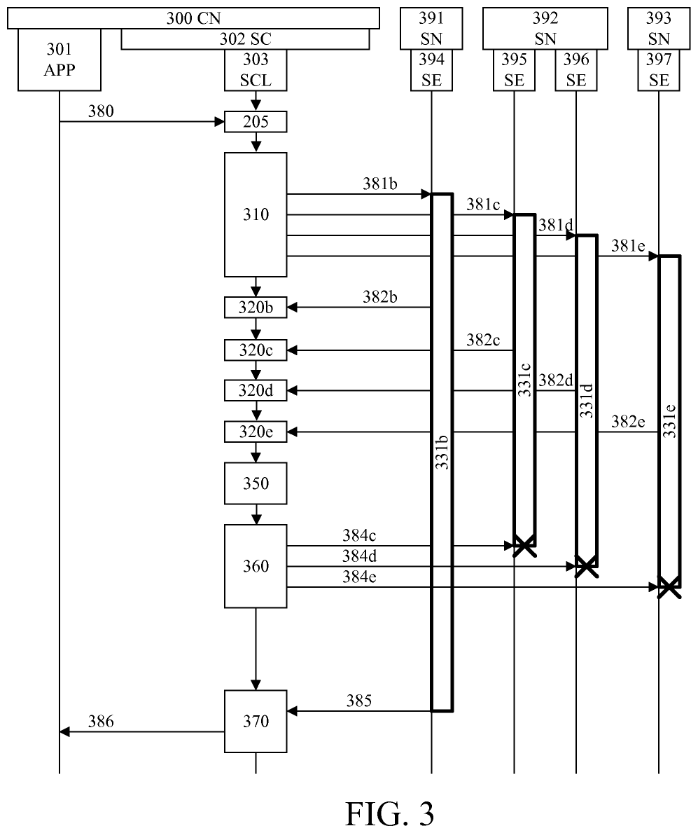

FIG. 4 schematically illustrates an example apparatus 410 according to some embodiments. The apparatus may, for example, be comprised in a client node (CN) 430. The client node may further comprise an application (APP) 440 and/or a local storage entity (LS) 450.

The apparatus comprises controlling circuitry (CNTR; e.g., a controller) 400 for management of performing a set of operations based on data, wherein a plurality of representations of the data are kept in respective ones of a plurality of storage entities. The controlling circuitry may, for example, be configured to cause execution of (e.g., execute) one or more of the method steps as described above in relation to FIGS. 1A, 1B, 2, and 3.

The controlling circuitry is configured to cause (for each of two or more storage entities of the plurality of storage entities) sending, to the storage entity, of a respective query relating to the data (compare with 110, 210, 310).

The controlling circuitry is also configured to cause (for each of the two or more storage entities of the plurality of storage entities) reception, from the storage entity, of a response to the query (compare with 120, 125, 220a-e, 320b-e). The response may comprise the representation of the data kept in the storage entity or an indicator of the representation of the data kept in the storage entity.

To this end the controlling circuitry may be associated with (e.g., connected—or connectable—to) a communication interface (I/O) 420. The communication interface may be configured to, for storage entities other than the local storage entity, send the respective query relating to the data and receive the response to the query.

Furthermore, the controlling circuitry is configured to cause (for each of at least two of the two or more storage entities) initiation of activities of performing the set of operations based on the representation of the data (compare with 130, 135, 230a-b, 310).

To this and, the communication interface 420 may be configured to send initiation signals according to some embodiments. Alternatively, the controlling circuitry may be configured to perform the set of operations itself.

The controlling circuitry is also configured to cause determination, based on the representations of the data or the indicators comprised in the responses, of one of the initiated activities of performing the set of operations (called the conclusive activity) as being based on a conclusive representation of the data or on representation of the data corresponding to a conclusive indicator (compare with 150, 250, 350).

To this end the controlling circuitry may comprise, or be otherwise associated with (e.g., connected—or connectable—to), a determiner (DET; e.g., determination circuitry) 401. The determiner may be configured to determine the conclusive activity.

The controlling circuitry is further configured to cause provision—e.g., to the application 440—of a result of the conclusive activity as result for performing the set of operations based on the data. To this and, the communication interface 420 may be configured to provide the result of the conclusive activity as result for performing the set of operations based on the data.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a client node (e.g., server, computer, etc.).

Embodiments may appear within an electronic apparatus (such as a client node) comprising arrangements, circuitry, and/or logic according to any of the embodiments described herein. Alternatively or additionally, an electronic apparatus (such as a client node) may be configured to perform methods according to any of the embodiments described herein.

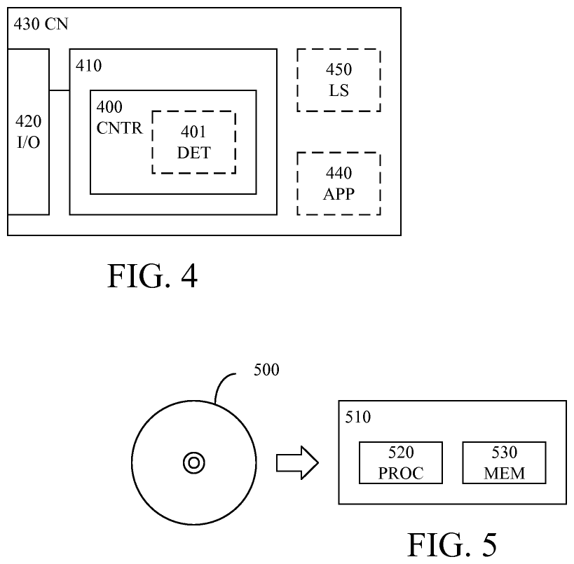

According to some embodiments, a computer program product comprises a computer readable medium such as, for example a universal serial bus (USB) memory, a plug-in card, an embedded drive or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC; e.g., data processing circuitry or a data processing unit) 520, which may, for example, be comprised in a client node 510. When loaded into the data processor, the computer program may be stored in a memory (MEM) 530 associated with or comprised in the data-processing unit. According to some embodiments, the computer program may, when loaded into and run by the data processing unit, cause execution of method steps according to, for example, any of the methods illustrated in FIGS. 1A, 1B, 2, 3, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-45. (canceled)

46. A method of a controller for management of performing a set of operations based on data, wherein a plurality of representations of the data are kept in respective ones of a plurality of storage entities, the method comprising:
for each of two or more storage entities of the plurality of storage entities:
sending, to the storage entity, a respective query relating to the data; and
receiving, from the storage entity, a response comprising the representation of the data kept in the storage entity;
for each of at least two of the two or more storage entities:
initiating an activity of performing the set of operations based on the representation of the data comprised in the response;
determining, based on the representations of the data comprised in the responses, one of the initiated activities as being based on a conclusive representation of the data, with the one initiated activity thus being a conclusive activity; and
causing provision of a result of the conclusive activity as result for performing the set of operations based on the data.

47. The method of claim 46, wherein activities of performing the set of operations are initiated only for storage entities for which the representation of the data comprised in the response differs from representations of the data comprised in previously received responses.

48. The method of claim 46, further comprising determining the conclusive representation of the data by taking a majority, or weighted majority, decision among the representations of the data comprised in the responses.

49. The method of claim 46, wherein the determination of the conclusive activity is performed before all initiated activities are completed.

50. The method of claim 46, wherein the activities are initiated before the determination of the conclusive activity.

51. The method of claim 46, wherein the conclusive representation coincides with the representation of the data kept in the storage entity for at least one of the two or more storage entities.

52. The method of claim 46, further comprising, in response to determining the conclusive activity, canceling initiated activities that are not based on the conclusive representation.

53. The method of claim 46, further comprising, in response to determining the conclusive activity, canceling all initiated activities, except for one that is based on the conclusive representation.

54. The method of claim 46, further comprising, before determining the conclusive activity, canceling or pausing initiated activities for which a probability of being based on the conclusive representation of the data falls below a probability threshold value.

55. The method of claim 46, wherein at least two of the two or more storage entities have differing signaling delay between the controller and the storage entity.

56. The method of claim 46, wherein a storage client comprises the controller and one of the two or more storage entities, and wherein the one storage entity keeps a representation of the data which is a default representation or a last known representation.

57. A method of a controller for management of performing a set of operations based on data, wherein a plurality of representations of the data are kept in respective ones of a plurality of storage entities, the method comprising:
for each of two or more storage entities of the plurality of storage entities:
sending, to the storage entity, a respective query relating to the data, thereby causing initiation of an activity of performing the set of operations based on the representation of the data kept in the storage entity; and
receiving, from the storage entity, a response comprising an indicator of the representation of the data kept in the storage entity;
determining, based on the indicators comprised in the responses, one of the initiated activities as being based on representation of the data corresponding to a conclusive indicator, with the one initiated activity thus being a conclusive activity; and
causing provision of a result of the conclusive activity as the result for performing the set of operations based on the data.

58. The method of claim 57, further comprising determining the conclusive indicator by taking a majority, or weighted majority, decision among the indicators comprised in the responses.

59. The method of claim 57, wherein the determination of the conclusive activity is performed before all initiated activities are completed.

60. The method of claim 57, wherein the activities are initiated before the determination of the conclusive activity.

61. The method of claim 57, wherein the representation of the data corresponding to the conclusive indicator coincides with the representation of the data kept in the storage entity for at least one of the two or more storage entities.

62. The method of claim 57, further comprising, in response to determining the conclusive activity, canceling initiated activities that are not based on the representation of the data corresponding to the conclusive indicator.

63. The method of claim 57, further comprising, in response to determining the conclusive activity, canceling all initiated activities, except for one that is based on the representation of the data corresponding to the conclusive indicator.

64. The method of claim 57, further comprising, before determining the conclusive activity, canceling or pausing initiated activities for which a probability of being based on representation of the data corresponding to the conclusive indicator falls below a probability threshold value.

65. The method of claim 57, wherein at least two of the two or more storage entities have differing signaling delay between the controller and the storage entity.

66. The method of claim 57, wherein a storage client comprises the controller and one of the two or more storage entities, and wherein the one storage entity keeps a representation of the data which is a default representation or a last known representation.

67. An apparatus for a controller and for management of performing a set of operations based on data, wherein a plurality of representations of the data are kept in respective ones of a plurality of storage entities, the apparatus comprising controlling circuitry configured to cause:
for each of two or more storage entities of the plurality of storage entities:
sending, to the storage entity, of a respective query relating to the data; and
reception, from the storage entity, of a response comprising the representation of the data kept in the storage entity;
for each of at least two of the two or more storage entities:
initiation of an activity of performing the set of operations based on the representation of the data comprised in the response;
determination, based on the representations of the data comprised in the responses, of one of the initiated activities as being based on a conclusive representation of the data, with the one initiated activity thus being a conclusive activity; and
provision of a result of the conclusive activity as result for performing the set of operations based on the data.

68. An apparatus for a controller and for management of performing a set of operations based on data, wherein a plurality of representations of the data are kept in respective ones of a plurality of storage entities, the apparatus comprising controlling circuitry configured to cause:
for each of two or more storage entities of the plurality of storage entities:
sending, to the storage entity, of a respective query relating to the data, thereby causing initiation of an activity of performing the set of operations based on the representation of the data kept in the storage entity; and
reception, from the storage entity, of a response comprising an indicator of the representation of the data kept in the storage entity;
determination, based on the indicators comprised in the responses, of one of the initiated activities as being based on representation of the data corresponding to a conclusive indicator, with the one initiated activity thus being a conclusive activity; and
provision of a result of the conclusive activity as result for performing the set of operations based on the data.
